(19) United States
(12) Patent Application Publication
(10) Pub. No.: US 2024/0083005 A1
(43) Pub. Date: Mar. 14, 2024

(54) Power Tool Drop Detection and Reorientation

(71) Applicant: Milwaukee Electric Tool Corporation, Brookfield, WI (US)

(72) Inventor: Jacob G. Wood, Waukesha, WI (US)

(21) Appl. No.: 18/458,454

(22) Filed: Aug. 30, 2023

Related U.S. Application Data
(60) Provisional application No. 63/405,689, filed on Sep. 12, 2022.

(51) Int. Cl. B25F 5/00; G01P 15/08; G01P 15/18

(52) U.S. Cl. CPC B25F 5/00; G01P 15/08; G01P 15/18

(57) ABSTRACT

A power tool includes a controller and an inertial measurement unit that generated acceleration data and rotational data associated with power tool. The controller determines that the power tool is in free fall and determines an orientation of the power tool based on the acceleration data and the rotational data. The controller applies a corrective torque to a motor of the power tool to reorient the power tool in effort to minimize damage that may occur when the power tool impacts a ground surface.

### RELATED APPLICATIONS

The present application is based on and claims priority from U.S. Patent Application No. 63/405,689, filed on Sep. 12, 2022, the entire disclosure of which is incorporated herein by reference.

### BACKGROUND

Power tools can be used for a variety of purposes such as cutting, drilling, driving, sanding, shaping, grinding, polishing, painting, heating, lighting, cleaning, gardening, and construction, among other uses. Power tools are designed to be reliable, robust, and to keep working despite drops, bumps, and the like.

### SUMMARY

As power tools become more complex mechanically and electrically, different complications can arise in terms of power tool reliability, especially when power tools are dropped from elevated surfaces. Depending on the orientation of the power tool when impacting the ground after being dropped, damage to mechanical and electrical components may be sustained. For example, if a power tool impacts the ground on its back near the location of a motor, more damage may occur than if the power tool impacts the ground on its handle near the location of a battery pack. Accordingly, power tool features that can avoid or minimize damage sustained by power tools during adverse events such as dropping from elevated surfaces is generally desired.

Some embodiments of the disclosure provide a power tool including a housing, a motor disposed in a first area of the housing, a battery disposed in a second area of the housing, an inertial measurement unit including circuitry configured to generate sensor data associated with the power tool, and a controller in communication with the inertial measurement unit and the motor. The controller includes a processor and a memory, and the processor executes instructions stored in the memory such that the controller is configured to determine that the power tool is in free fall based on the sensor data generated by the inertial measurement unit, determine an orientation of the power tool relative to a ground surface based on the sensor data generated by the inertial measurement unit, determine a corrective torque control to apply to the motor based on the orientation of the power tool, and apply the corrective torque control to the motor to reorient the power tool during the free fall.

Some embodiments of the disclosure provide a method including determining, by a power tool, that the power tool is in free fall based on sensor data generated by an inertial measurement unit of the power tool; determining, by the power tool, an orientation of the power tool relative to a ground surface based on the sensor data generated by the inertial measurement unit of the power tool; determining, by the power tool, a corrective torque control to apply to a motor of the power tool based on the orientation of the power tool; and applying, by the power tool, the corrective torque control to the motor to reorient the power tool during free fall.

Some embodiments of the disclosure provide a power tool including a housing, a motor, a battery, an inertial measurement unit including circuitry configured to generate sensor data associated with the power tool, and a controller in communication with the inertial measurement unit and the motor. The controller includes a processor and a memory, and the processor executes instructions stored in the memory such that the controller is configured to determine that the power tool is in free fall based on the acceleration data generated by the inertial measurement unit, determine a corrective control signal to apply to the motor during the free fall, and apply the corrective control signal to the motor to reorient the power tool during the free fall.

### BRIEF DESCRIPTION OF THE DRAWINGS

The accompanying drawings, which are incorporated in and form a part of this specification, illustrate embodiments of the disclosure and, together with the description, explain principles of the embodiments.

FIG. 1 is an illustration of an example power tool that can perform drop detection and reorientation functionality.

FIG. 2 is a block diagram illustrating example components of the power tool of FIG. 1.

FIG. 3 is an illustration of an example inertial measurement unit that can be provided in the power tool of FIG. 1.

FIG. 4 is an illustration of an example motor that can be provided in the power tool of FIG. 1.

FIG. 5 is a flowchart illustrating an example process for drop detection and reorientation that can be performed by the power tool of FIG. 1.

FIGS. 6A-6D are example illustrations of the steps performed by the power tool of FIG. 1 when implementing the drop detection and reorientation process of FIG. 5.

FIG. 7 is a flowchart illustrating another example process for drop detection and reorientation that can be performed by the power tool of FIG. 1.

### DETAILED DESCRIPTION

A power tool can be configured to minimize damage that may occur from adverse events such as dropping the power tool from an elevated surface. Depending on the orientation of a dropped power tool when it impacts the ground, damage to mechanical and electrical components may be sustained by the power tool. The present disclosure provides a power tool that can detect that it has been dropped, and reorient itself to minimize damage that may result from the drop. The power tool can use both acceleration data and rotational data from an inertial measurement unit to determine that the power tool is in free fall and to determine the orientation of the power tool. Based on the orientation, the power tool can determine and apply a corrective torque or other type of corrective control signal to a motor of the power tool to reorient the power tool during the free fall.

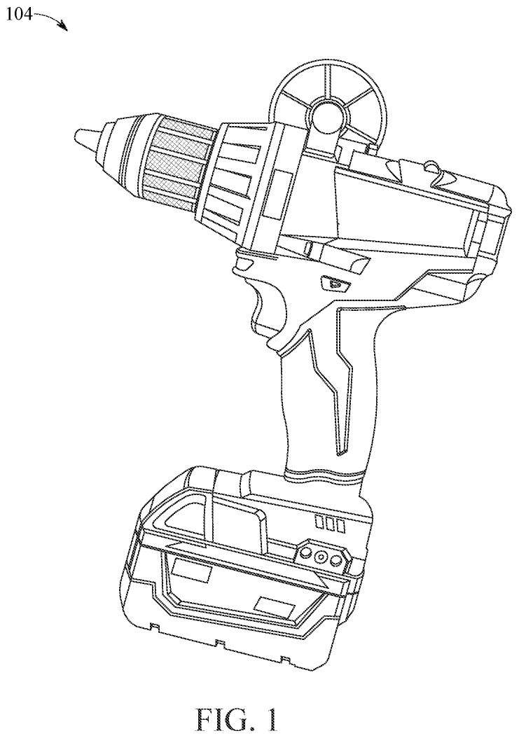

FIG. 1 shows an illustration of an example power tool 104 that can perform drop detection and reorientation functionality. Power tool 104 as illustrated in FIG. 1 is a motorized power drill-driver, however it is important to note that a variety of different power tools can be designed to perform the drop detection and reorientation functionality described herein. For example, drop detection and reorientation functionality can be provided in tools such as an impact driver, a hammer drill, a pipe cutter, a sander, a nailer, a grease gun, a crimper, or any other suitable type of power tool. Power tool 104 as illustrated in FIG. 1 includes a battery pack disposed on the bottom of a handle of power tool 104 and a motor disposed within an upper housing portion of power tool 104. In this example implementation of power tool 104, in the event of a drop from an elevated surface, damage to power tool 104 is more likely to be minimized if power tool 104 impacts the ground in an area near the battery than if power tool 104 impacts the ground in an area near the motor. In other implementations of the power tool 104, impacting the ground at another area of the power tool 104 may minimize damage.

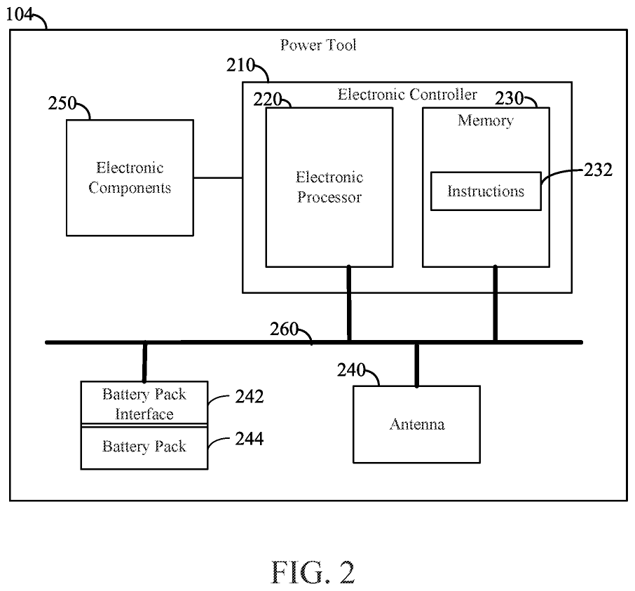

FIG. 2 shows a block diagram illustrating example components of power tool 104. As shown, power tool 104 includes an electronic controller 210, which includes an electronic processor 220 and memory 230. Power tool 104 as shown also includes an antenna 240, a battery pack interface 242, a battery pack 244, a set of electronic components 250, and a communication bus 260. Memory 230 stores instructions 232 that can be executed by electronic processor 220 such that electronic processor 230 implements operations for power tool 104 in accordance with instructions 232. The operations implemented by electronic processor 220 can include sending and receiving data via communication bus 260 and antenna 240, for example. Power tool 104 can include additional and/or alternative components for communication and other functionality beyond these example components illustrated in FIG. 2. For example, in some examples, the antenna 240 is not included in power tool 104.

Memory 230 can be implemented using any suitable type or types of memory, including read-only memory (ROM), random access memory (RAM), volatile memory, non-volatile, other non-transitory computer-readable media, and/or various combinations thereof. Data stored in memory 230, including instructions 232, can be generated by a wireless device (e.g., a smartphone, a laptop, a tablet, etc.), a server connected to power tool 104, other power tools (e.g., at the same job site), or other systems and/or devices. Some of the data stored in memory 230 can be loaded onto power tool 104 at the time of manufacturing, and other data can be stored in memory 230 during the operational lifetime of power tool 104. Electronic processor 220 can be implemented using a variety of different types and/or combinations of processing components and circuitry, including various types of microprocessors, central processing units (CPUs), and the like.

Antenna 240 can be communicatively coupled to electronic controller 210. Antenna 240 can enable electronic controller 210 (and, thus, the power tool 104) to communicate with other devices, such as with wireless communication devices, one or more servers, and other power tools connected to a network. Antenna 240 can facilitate a communication via Bluetooth, Wi-Fi, and other types of communications protocols. In some examples, antenna 240 can further include a global navigation satellite system (GNSS) receiver of a global positioning system (GPS) that receives signals from satellites, land-based transmitters, and the like.

Battery pack interface 242 can be configured to selectively receive and interface with battery pack 244 such that battery pack 244 serves as a power source for power tool 104. Battery interface 242 can include one or more power terminals and, in some cases, one or more communication terminals that interface with respective power terminals, communication terminals, etc., of battery pack 244. Battery pack 244 can include one or more battery cells of various chemistries, such as lithium-ion (Li-Ion), nickel cadmium (Ni-Cad), etc. Battery pack 244 can further selectively latch and unlatch (e.g., with a spring-biased latching mechanism) to power tool 104 to prevent unintentional detachment. Battery pack 244 can further include a pack electronic controller (pack controller) including a processor and a memory. The pack controller can be configured similarly to electronic controller 210. The pack controller can be configured to regulate charging and discharging of the battery cells, and/or to communicate with the electronic controller 210. Battery pack 244 can further include an antenna, like antenna 240, coupled to the pack controller via a bus like bus 260. Accordingly, battery pack 244 can be configured to communicate with other devices, such as wireless communication devices or other power tools. Battery pack 244 can communicate battery status information (e.g., percent charged, charging rate, charger connection status, etc.) to electronic controller 210 via battery pack interface 242.

Battery pack 244 can be coupled to and configured to power the various components of the power tool 104, such electronic controller 210, the antenna 240, and electronic components 250. However, to simplify the illustration, power line connections between the pack 244 and these components are not illustrated. While the example illustration in FIG. 2 shows power tool 104 being powered by battery pack 244, it is important to note that different types of power sources can be used to provide power to power tool 104. For example, power tool 104 could be powered by a wired connection to a power outlet, or other sources of power.

Electronic components 250 can be implemented in a variety of different ways and can include a variety of different components depending on the type of power tool. For example, for a motorized power tool (e.g., drill-driver, saw, etc.), electronic components 250 can include, for example, an inverter bridge, a motor (e.g., brushed or brushless) for driving a tool implement, and the like. Electronic components 250 can also include different types of sensors, among other suitable components.

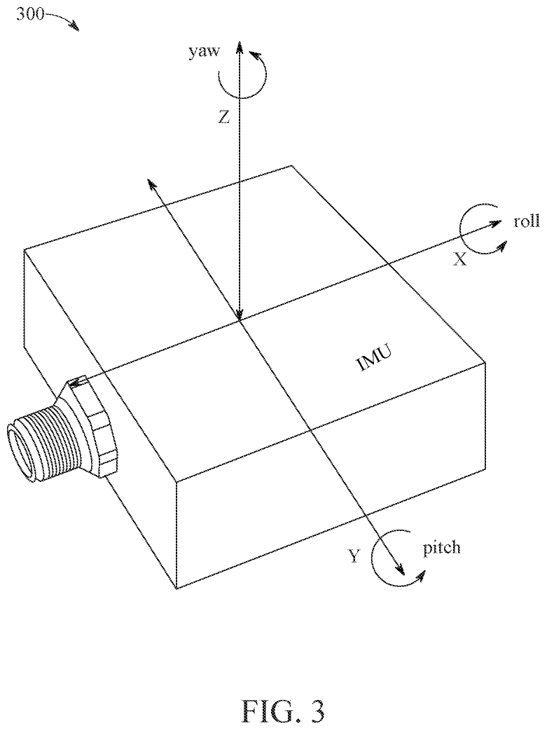

FIG. 3 shows an illustration of an example inertial measurement unit (IMU) 300 that can be provided in power tool 104. Inertial measurement unit 300 generally is a sensing device that can measure and report sensor data regarding variables such as specific force, angular rate, and orientation of power tool 104. Inertial measurement unit 300 can include components such as accelerometers, gyroscopes, and magnetometers that can be designed to generate this data. Different types of inertial measurement units and/or other types of similar motion sensors and/or combinations thereof can be used to implement inertial measurement unit 300. Inertial measurement unit 300 can be provided in power tool 104 in various configurations depending on the type of power tool and other factors. Inertial measurement unit 300 can be part of electronic components 250, and can receive data from and transmit data to electronic controller 210 in a variety of suitable manners, including via wired and/or wireless communications protocols.

As illustrated in FIG. 3, inertial measurement unit can detect changes in roll, pitch, and yaw. Roll can be defined by an x-axis (first axis) along a width of inertial measurement unit 300, and pitch can be defined by a y-axis (second axis) perpendicular to the x-axis along a length of inertial measurement unit 300. Yaw can be defined by a z-axis (third axis) perpendicular to both the x-axis and the y-axis and extending vertically above and below a surface of inertial measurement unit 300. Based on changes sensed by inertial measurement unit 300 in the orientation of power tool 104 in terms of roll, pitch, and/or yaw, power tool 104 can both determine that it is in a state of free fall and initiate corrective actions to correct its orientation to minimize damage that can result from impacting the ground after free fall. Inertial measurement unit 300 can generate sensor data that includes both acceleration data (e.g., using one or more accelerometers) and rotational data (e.g., using one or more gyroscopes) that may be used in drop detection and reorientation of power tool 104.

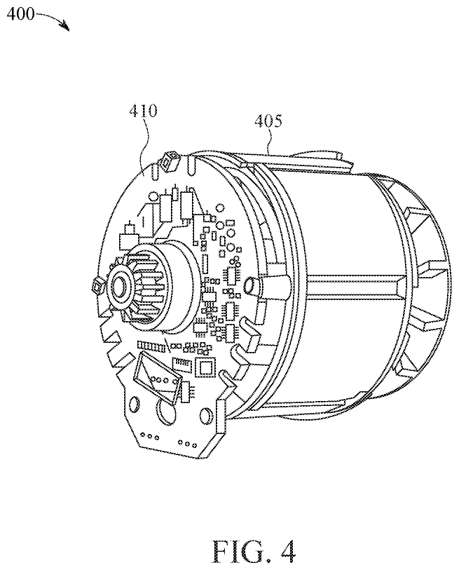

FIG. 4 shows an illustration of an example motor 400 that can be provided in power tool 104. Motor 400 can be implemented in a variety of ways, including using different types, configurations, and/or quantities of motors, depending on the type of power tool. For example, motor 400 can be an electronically controlled brushless motor that is within a housing of power tool 104. Motor 400 can be implemented using a variety of different types and configurations (e.g., pole configurations) of magnets and other types of motor components. In some examples, motor 400 is a permanent magnet brushless motor including a permanent magnet rotor and a stator with pairs of stator windings. In FIG. 4, motor 400 includes a motor body 405 (including, in this example, an inner rotor and outer stator) and motor control printed circuit board (motor PCB) 410 with, for example, one or more of an inverter bridge or a rotor position sensor (e.g., one or more Hall sensors). To drive motor 400, electronic controller 210 may generate motor control signals to the inverter bridge, which causes selective application of current (e.g., from battery pack 244) to stator coils of the stator, which drives rotation of the rotor in a desired direction, speed, and/or acceleration. When power tool 104 is operated by a user, motor 400 may be controlled by electronic controller 210 responsive to a sensed manipulation of a trigger of power tool 104 (see FIG. 1) by the user. Motor 400 may drive an output unit, which may vary by the type of power tool. For example, in the power drill example of power tool 104 illustrated in FIG. 1, motor 400 may drive a drill chuck that ultimately drives a drill driver bit or drill bit. In a saw example of the power tool 104, such as a circular saw or reciprocating saw, motor 400 may ultimately drive a saw blade. Further, in some examples, rather than a direct drive of the output unit of power tool 104, a transmission (e.g., including two or more gears) may be provided between motor 400 and the output unit of power tool 104. Responsive to data generated by inertial measurement unit 300, electronic controller 210 can control operation of motor 400 to affect the orientation of power tool 104. For example, if inertial measurement unit 300 senses that power tool 104 is in free fall, electronic controller 210 can provide one or more control signals to motor 400 to adjust the torque of motor 400 to rotate power tool 104 in midair to reduce the possibility that power tool 104 sustains damage when impacting the ground.

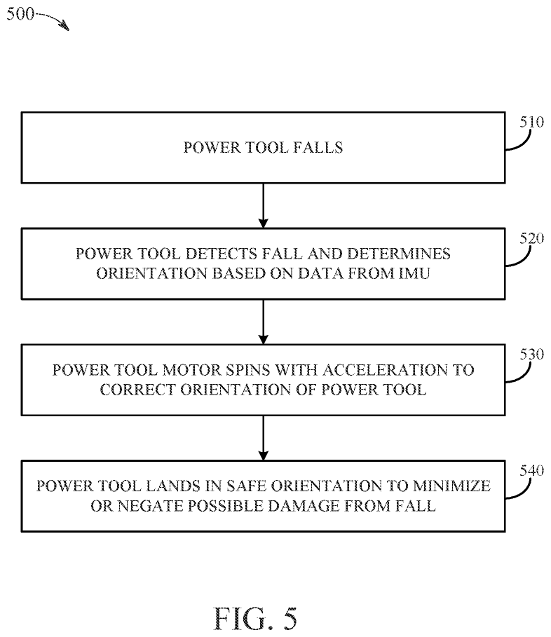

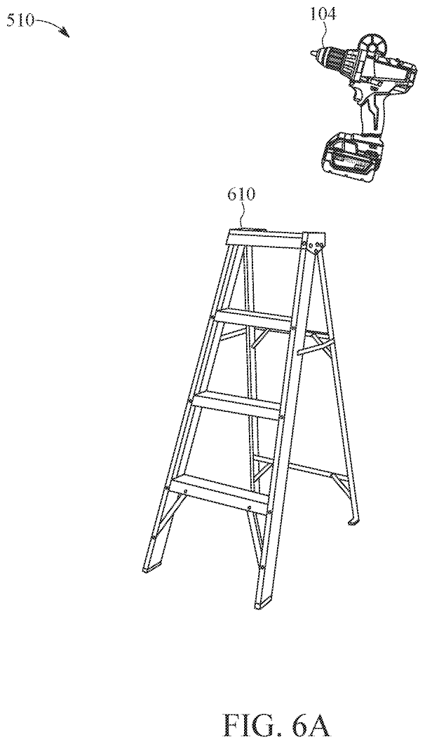

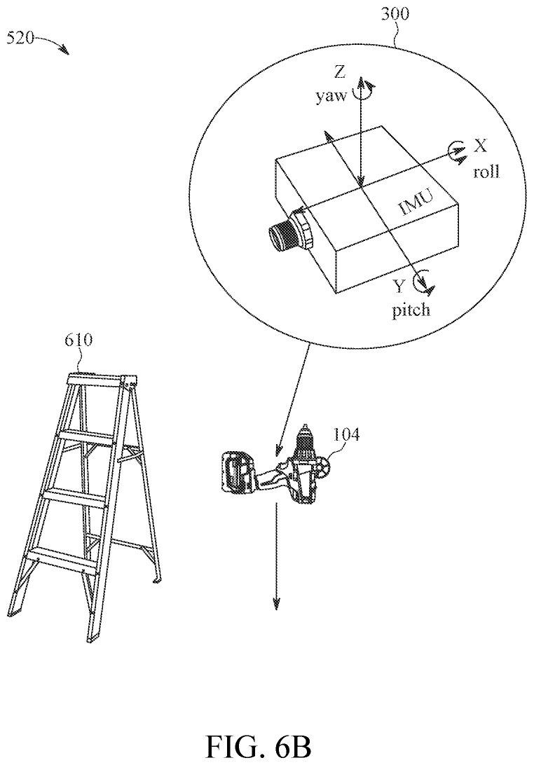

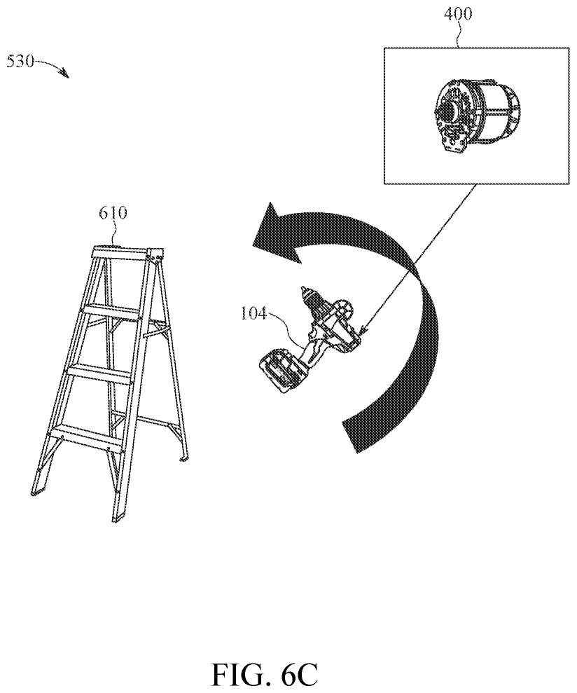

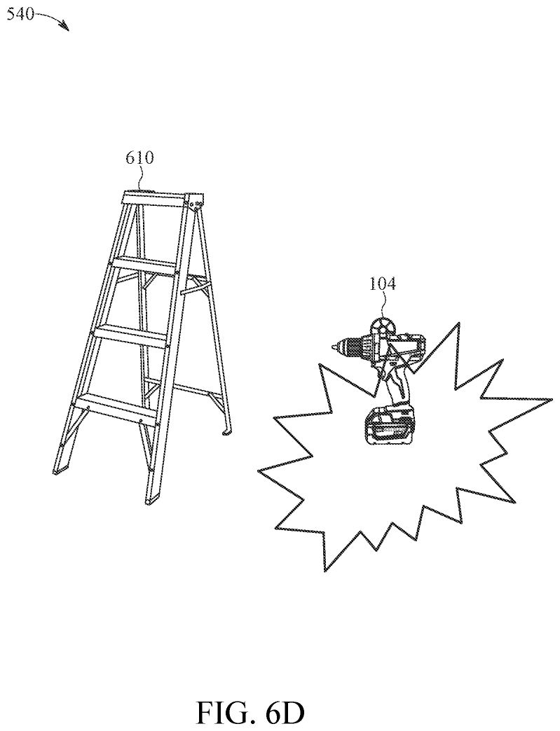

FIG. 5 shows a flowchart illustrating an example process 500 for drop detection and reorientation that can be performed by power tool 104. FIGS. 6A-6D show example illustrations of the steps performed by power tool 104 when implementing process 500. Process 500 generally involves different components of power tool 104, including electronic controller 210, inertial measurement unit 300, and motor 400. The ability of power tool 104 to perform process 500 (e.g., by executing instructions 232 for performing process 500, where instructions 232 are stored on power tool 104 at the time of manufacturing and/or downloaded to power tool 104 by a customer) can provide improved durability and reliability for power tool 104. Accordingly, process 500 can extend the usable lifetime of power tool 104 and reduce required maintenance associated with power tool 104, thereby providing improvements in terms of tool operation, cost, and efficiency. Although the blocks of process 500 are illustrated in a particular order, in some examples, one or more of the blocks of process 500 are executed in parallel, in a different order, or bypassed.

At block 510, power tool 104 falls from an elevated surface. As shown in FIG. 6A, power tool 104 falls from the top of a ladder 610. Power tool 104 can be accidentally knocked off the top of ladder 610 after a worker bumps into ladder 610, for example. Wind or some other external force can also cause power tool 104 to fall from ladder 610. Power tool 104 can generally fall from a variety of different types of surfaces and structures, such as from a workbench, a chair, a vehicle (e.g., a truck bed), a drilling station, a user's hand, or any other type of elevated surface that power tool 104 can be placed on. Different types of jobsites and locations where power tool 104 can be used can create a variety of different scenarios in which power tool 104 could enter a state of free fall, and possibly sustain damage upon impacting the ground.

At block 520, power tool 104 detects the fall and the orientation of power tool 104 based on sensor data from the inertial measurement unit 300. For example, as shown in FIG. 6B, power tool 104 can use acceleration data and rotational data generated by inertial measurement unit 300 to detect that power tool 104 has fallen from the top of ladder 610 and that power tool 104 is oriented generally horizontally. In the horizontal orientation, power tool 104 is likely to impact a ground surface (e.g., a floor indoors, the ground outdoors, etc.) at a first area of the housing or power tool 104 surrounding motor 400, such that motor 400 may sustain significant damage from the fall. The acceleration data generated by inertial measurement unit 300, such as a vector sum of acceleration readings along the x, y, and z axes (roll, pitch, and yaw), can be used by power tool 104 to determine that power tool 104 is in free fall. For example, when power tool 104 is resting on a surface, the vector sum of acceleration readings may generally equate to acceleration due to gravity (approximately 9.8 m/s²). Deviation from this value may indicate free fall. For example, the electronic controller 210 can compare the vector sum to a threshold value (e.g., 1 m/s², 2 m/s², etc.) and, if the vector sum of the acceleration readings is less than the threshold value, then power tool 104 can determine that it is in free fall. The threshold value can be predetermined or configurable based on the type of power tool and the intended application. In some examples, electronic controller 210 may also condition a determination of free fall based on the vector sum being sustained above the threshold or above the threshold and stable (e.g., staying with a predefined stability range) for at least a predetermined amount of time (e.g., more than 0.5 seconds, 1 second, 1.5 seconds, etc.). Further, in some examples, to reduce the likelihood of electronic controller 210 detecting a free fall condition when power tool 104 is not in free fall (a false positive), the electronic controller 210 compares the vector sum to a threshold range associated with free fall (e.g., having an upper and a lower bounding threshold value). When the vector sum is within this range (e.g., momentarily or for at least a predetermined amount of time), the electronic controller 210 determines that power tool 104 is in free fall. This range may be defined to be relatively small and based on measured accelerations from experimentation to reduce false positives. The rotational data generated by inertial measurement unit 300 can be used by power tool 104 to determine the orientation of power tool 104 with respect to the x, y, and z axes (roll, pitch, and yaw). For example, electronic controller 210 may continuously integrate pitch, roll, and yaw outputs from the IMU 300 and combine with the vector sum of acceleration using a Kalman filter to determine and track orientation of power tool 104.

At block 530, motor 400 spins with an acceleration to correct the orientation of power tool 104. As shown in FIG. 6C, motor 400 spins to reorient power tool 104 in a generally counterclockwise direction from the perspective view shown. More particularly, controller 210 may output one or more motor control signals (a corrective torque control) to drive motor 400, which causes a rotor of motor 400 to rotate and generate a corrective torque, which causes the orientation of power tool 104 to change. Power tool 104 can determine an appropriate corrective torque control to apply to motor 400 based on the sensor data (e.g., one or both of the acceleration data and the rotational data) generated by inertial measurement unit 300, and then apply the corrective torque control by providing one or more control signals to motor 400. As a result of the applied corrective torque control, motor 400 spins in an appropriate direction with an appropriate rotational displacement, speed, and/or acceleration to create a force that reorients power tool 104 in accordance with a preferred drop orientation.

In some implementations, electronic controller 210 can determine the appropriate torque control to apply to motor 400 by taking a cross product of a current orientation vector and a preferred drop vector, and multiplying the cross product by an inertia constant specific to power tool 104 to generate a torque request. Electronic controller 210 can then apply the corrective torque control corresponding to the torque request to motor 400 such that motor 400 spins according to the torque request. The force generated by the spinning of motor 400 corrects the orientation of power tool 104 in midair during free fall. For example, in the case of motor 400 implemented as a permanent magnet brushless motor, the corrective torque control may include one or more pulse width modulated (PWM) signals having respective duty cycles (between 0-100%) provided to an inverter bridge of motor 400. The inverter bridge may include a plurality of power switching elements (e.g., six or another number of field effect transistors (FETs)) that are coupled between positive and negative direct current (DC) voltage lines or rails. The inverter bridge may, based on the received corrective torque control, selectively apply current to one or more stator coils of a stator of motor 400, which generates a changing magnetic field that drives a permanent magnet rotor of motor 400.

For example, each FET pair of the inverter bridge may have a midpoint connected to a terminal of motor 400, where each terminal of motor 400 is connected to one or more stator coils of the stator of motor 400. Electronic controller 210 may further receive or determine motor position feedback data (e.g., from one or more Hall sensors that sense a position of the rotor magnets of motor 400), which may influence or trigger selective application of current to the one or more stator coils. For example, the stator of motor 400 may include pairs of stator coils that are selectively driven in a repeating sequence as the rotor of motor 400 rotates. To drive motor 400 in a first rotational direction, a first repeating sequence may be used, and to drive motor 400 in a second (opposite) direction, a second repeating sequency may be used that is the reverse order of the first repeating sequence. In some examples, generally, the larger the duty cycle of the PWM control signals to the inverter bridge, the more motor torque produced by motor 400.

At block 540, power tool 104 lands in a safe orientation to minimize (i.e., reduce or avoid) possible damage from the fall. For example, as shown in FIG. 6D, power tool 104 impacts the ground surface in a second area of the housing near the battery, such that the likelihood of incurring damage to motor 400 and other key components of power tool 104 is substantially reduced. If power tool 104 were to impact the ground surface in the first area of the housing near motor 400, the likelihood of incurring damage to motor 400 and other key components of power tool 104 may be significantly higher. Accordingly, by using the data from inertial measurement unit 300 to apply the corrective torque to motor 400, the durability of power tool 104 can be increased.

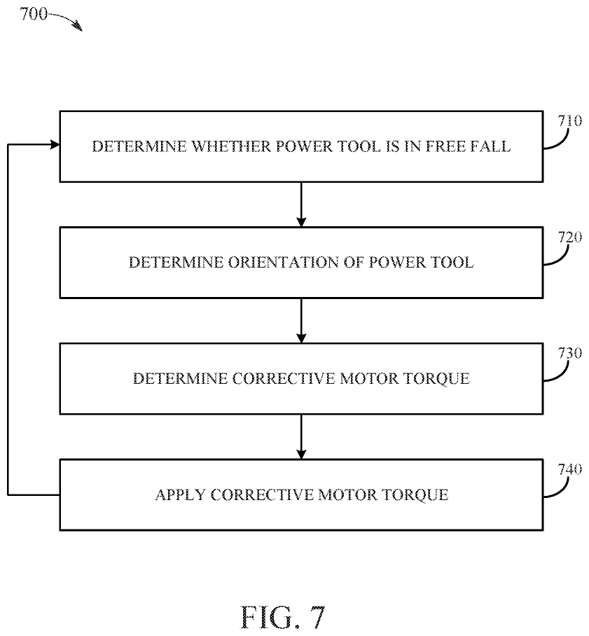

FIG. 7 shows a flowchart illustrating another example process 700 for drop detection and reorientation that can be performed by power tool 104. Process 700 generally involves different components of power tool 104, including electronic controller 210, inertial measurement unit 300, and motor 400. The ability of power tool 104 to perform process 700 (e.g., by executing instructions 232 for performing process 700, where instructions 232 are stored on power tool 104 at the time of manufacturing and/or downloaded to power tool 104 by a customer) can provide improved durability and reliability for power tool 104. Accordingly, process 700 can extend the usable lifetime of power tool 104 and reduce required maintenance associated with power tool 104, thereby providing improvements in terms of cost and efficiency. Although the blocks of process 700 are illustrated in a particular order, in some examples, one or more of the blocks of process 700 are executed in parallel, in a different order, or bypassed.

At block 710, power tool 104 determines whether it is in free fall based on sensor data from IMU 300. For example, electronic processor 220 can use a vector sum of acceleration readings along the x, y, and z axes (roll, pitch, and yaw) generated by inertial measurement unit 300 to determine that power tool 104 is in free fall. The vector sum of acceleration readings along the x, y, and z axes (roll, pitch, and yaw) data can be compared to a threshold value (e.g., 1 m/s², 2 m/s², etc.) and, if the vector sum of the acceleration readings is above the threshold, then power tool 104 can determine that it is in free fall. The threshold value can be predetermined or configurable based on the type of power tool and the intended application. Moreover, electronic processor 210 can determine that power tool 104 is in free fall without necessarily calculating a vector sum of acceleration readings in each of the x, y, and z directions. For example, electronic processor 210 may only be concerned with acceleration in the z direction to determine whether power tool 104 is in free fall, among other possible approaches to processing the sensor data generated by inertial measurement unit 300 to determine that power tool 104 is in free fall.

At block 720, power tool 104 determines its orientation based on the sensor data from IMU 300. For example, electronic processor 210 can use rotational data generated by inertial measurement unit 300 to determine its orientation. The rotational data generated by inertial measurement unit 300 can provide positional data and/or angular velocity data that can be used by electronic processor 210 to determine the orientation of power tool 104 along the x, y, and z axes (roll, pitch, and yaw). Various vector calculations and different types of logic can be executed by electronic processor 210 using the rotational data generated by inertial measurement unit 300 to determine the current orientation of power tool 104.

At block 730, power tool 104 determines a corrective torque control that can be applied to motor 400 to create a reorientation effect. For example, electronic processor 210 can determine an appropriate corrective torque control to apply to motor 400 by taking a cross product of a current orientation vector and a preferred drop vector, and then multiplying the cross product by an inertia constant specific to power tool 104 to generate a torque request. The orientation vector represents the orientation of power tool 104 determine at block 720, for example using the rotational data generated by inertial measurement unit 300. The preferred drop vector represents a preferred orientation of power tool 104 when it impacts a ground surface to minimize damage to power tool 104 (e.g., prefer to land on battery as opposed to motor). The specific inertia constant can vary based on the type of power tool, and generally can be used to ensure that applying the corrective torque to motor 400 generates enough force to reorient power tool 104.

This calculation can be represented by the equation: K·<x, y, z>×<a, b, c>=TorqueRequest, where K is the specific inertia constant, <x, y, z> is the orientation vector, and <a, b, c> is the preferred drop vector. The preferred drop vector and/or specific inertia constant may be stored in the memory 230 or otherwise provided to the electronic controller 210 in advance of the process 700 (e.g., at the time of manufacture of power tool 104). These values may be derived from experimentation (e.g., drop testing and evaluation of resulting damage). Further, it will be appreciated that various other types of calculations can be performed by power tool 104 at block 730 to determine corrective control signals to apply to motor 400. For example, power tool 104 can calculate an appropriate rotational speed of motor 400, an amount of current to apply to one or more stator coils of a stator of motor 400, and/or other calculations used to generate corrective control signals more generally such that power tool 104 does not necessarily explicitly calculate torque to perform reorientation functionality.

At block 740, power tool 104 applies the corrective torque control to motor 400 to reorient power tool 104. For example, electronic processor 210 can provide one or more control signals to motor 400 (e.g., via communication bus 260) to apply the corrective torque control (or other corrective control signal) to motor 400. By applying the corrective torque control to motor 400, motor 400 may generate corrective torque that reorients power tool 104 such that power tool 104 is more likely to impact the ground surface in a favorable spot to reduce the likelihood of sustaining damage to components of power tool 104. For further discussion of generating corrective torque with motor 400 based on motor torque control, see above discussion of the motor control related to block 530.

In some examples, after block 740, process 700 can optionally loop back to block 710, where power tool 104 can determine whether it is still in free fall after applying the corrective torque to motor 400. If power tool 104 is still in free fall, the corrective torque control can be viewed as a first corrective torque control, and power tool 104 can repeat steps 710, 720, 730, and 740 to apply a second corrective torque control to motor 400 based on a second orientation of power tool 104.

It is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

As used herein, unless otherwise limited or defined, discussion of particular directions is provided by example only, with regard to particular embodiments or relevant illustrations. For example, discussion of “top,” “front,” or “back” features is generally intended as a description only of the orientation of such features relative to a reference frame of a particular example or illustration. Correspondingly, for example, a “top” feature can sometimes be disposed below a “bottom” feature (and so on), in some arrangements or embodiments. Further, references to particular rotational or other movements (e.g., counterclockwise rotation) is generally intended as a description only of movement relative a reference frame of a particular example of illustration.

In some embodiments, including computerized implementations of methods according to the disclosure, can be implemented as a system, method, apparatus, or article of manufacture using standard programming or engineering techniques to produce software, firmware, hardware, or any combination thereof to control a processor device (e.g., a serial or parallel processor chip, a single- or multi-core chip, a microprocessor, a field programmable gate array, any variety of combinations of a control unit, arithmetic logic unit, and processor register, and so on), a computer (e.g., a processor device operatively coupled to a memory), or another electronically operated controller to implement aspects detailed herein. Accordingly, for example, embodiments of the disclosure can be implemented as a set of instructions, tangibly embodied on a non-transitory computer-readable media, such that a processor device can implement the instructions based upon reading the instructions from the computer-readable media. Some embodiments of the disclosure can include (or utilize) a control device such as an automation device, a computer including various computer hardware, software, firmware, and so on, consistent with the discussion below. As specific examples, a control device can include a processor, a microcontroller, a field-programmable gate array, a programmable logic controller, logic gates etc., and other typical components that are known in the art for implementation of appropriate functionality (e.g., memory, communication systems, power sources, user interfaces and other inputs, etc.). Also, functions performed by multiple components can be consolidated and performed by a single component. Similarly, the functions described herein as being performed by one component can be performed by multiple components in a distributed manner. Additionally, a component described as performing particular functionality can also perform additional functionality not described herein. For example, a device or structure that is “configured” in a certain way is configured in at least that way, but can also be configured in ways that are not listed.

The term “article of manufacture” as used herein is intended to encompass a computer program accessible from any computer-readable device, carrier (e.g., non-transitory signals), or media (e.g., non-transitory media). For example, computer-readable media can include but are not limited to magnetic storage devices (e.g., hard disk, floppy disk, magnetic strips, and so on), optical disks (e.g., compact disk (CD), digital versatile disk (DVD), and so on), smart cards, and flash memory devices (e.g., card, stick, and so on). Additionally, it should be appreciated that a carrier wave can be employed to carry computer-readable electronic data such as those used in transmitting and receiving electronic mail or in accessing a network such as the Internet or a local area network (LAN). Those skilled in the art will recognize that many modifications can be made to these configurations without departing from the scope or spirit of the claimed subject matter.

Certain operations of methods according to the disclosure, or of systems executing those methods, can be represented schematically in the figures or otherwise discussed herein. Unless otherwise specified or limited, representation in the figures of particular operations in particular spatial order can not necessarily require those operations to be executed in a particular sequence corresponding to the particular spatial order. Correspondingly, certain operations represented in the figures, or otherwise disclosed herein, can be executed in different orders than are expressly illustrated or described, as appropriate for particular embodiments of the disclosure. Further, in some embodiments, certain operations can be executed in parallel, including by dedicated parallel processing devices, or separate computing devices configured to interoperate as part of a large system.

As used herein in the context of computer implementation, unless otherwise specified or limited, the terms “component,” “system,” “module,” etc. are intended to encompass part or all of computer-related systems that include hardware, software, a combination of hardware and software, or software in execution. For example, a component can be, but is not limited to being, a processor device, a process being executed (or executable) by a processor device, an object, an executable, a thread of execution, a computer program, or a computer. By way of illustration, both an application running on a computer and the computer can be a component. One or more components (or system, module, and so on) can reside within a process or thread of execution, can be localized on one computer, can be distributed between two or more computers or other processor devices, or can be included within another component (or system, module, and so on).

In some implementations, devices or systems disclosed herein can be utilized or installed using methods embodying aspects of the disclosure. Correspondingly, description herein of particular features, capabilities, or intended purposes of a device or system is generally intended to inherently include disclosure of a method of using such features for the intended purposes, a method of implementing such capabilities, and a method of installing disclosed (or otherwise known) components to support these purposes or capabilities. Similarly, unless otherwise indicated or limited, discussion herein of any method of manufacturing or using a particular device or system, including installing the device or system, is intended to inherently include disclosure, as embodiments of the disclosure, of the utilized features and implemented capabilities of such device or system.

As used herein, unless otherwise defined or limited, ordinal numbers are used herein for convenience of reference based generally on the order in which particular components are presented for the relevant part of the disclosure. In this regard, for example, designations such as “first,” “second,” etc., generally indicate only the order in which the relevant component is introduced for discussion and generally do not indicate or require a particular spatial arrangement, functional or structural primacy or order.

As used herein, unless otherwise defined or limited, directional terms are used for convenience of reference for discussion of particular figures or examples. For example, references to downward (or other) directions or top (or other) positions can be used to discuss aspects of a particular example or figure, but do not necessarily require similar orientation or geometry in all installations or configurations.

As used herein, unless otherwise defined or limited, the phase “and/or” used with two or more items is intended to cover the items individually and the items together. For example, a device having “a and/or b” is intended to cover: a device having a (but not b); a device having b (but not a); and a device having both a and b.

This discussion is presented to enable a person skilled in the art to make and use embodiments of the disclosure. Various modifications to the illustrated examples will be readily apparent to those skilled in the art, and the generic principles herein can be applied to other examples and applications without departing from the principles disclosed herein. Thus, embodiments of the disclosure are not intended to be limited to embodiments shown, but are to be accorded the widest scope consistent with the principles and features disclosed herein and the claims below. The detailed description is to be read with reference to the figures, in which like elements in different figures have like reference numerals. The figures, which are not necessarily to scale, depict selected examples and are not intended to limit the scope of the disclosure. Skilled artisans will recognize the examples provided herein have many useful alternatives and fall within the scope of the disclosure.

Various features and advantages of the disclosure are set forth in the following claims.

1. A power tool comprising:
a housing;
a motor disposed in a first area of the housing;
a battery disposed in a second area of the housing;
an inertial measurement unit comprising circuitry that is configured to generate sensor data associated with the power tool; and
a controller in communication with the inertial measurement unit and the motor, the controller comprising a processor and a memory, the processor configured to execute instructions stored in the memory such that the controller is configured to:
determine that the power tool is in free fall based on the sensor data generated by the inertial measurement unit;
determine an orientation of the power tool relative to a ground surface based on the sensor data generated by the inertial measurement unit;
determine a corrective torque control to apply to the motor based on the orientation of the power tool; and
apply the corrective torque control to the motor to reorient the power tool during the free fall.

2. The power tool of claim 1, wherein the sensor data comprises acceleration data and rotational data, and wherein the controller is configured to:
determine that the power tool is in the free fall based on the acceleration data generated by the inertial measurement unit; and
determine the orientation of the power tool relative to the ground surface based on the rotational data generated by the inertial measurement unit.

3. The power tool of claim 2, wherein the controller is configured to determine that the power tool is in free fall by comparing the acceleration data to a threshold.

4. The power tool of claim 1, wherein the controller is configured to determine the corrective torque control to apply to the motor by calculating a cross product of an orientation vector and a preferred drop vector for the power tool.

5. The power tool of claim 4, wherein the controller is configured to determine the corrective torque control to apply to the motor by multiplying the cross product by an inertia constant specific to the power tool.

6. The power tool of claim 1, wherein the controller is further configured to:
determine that the power tool is still in free fall after applying the corrective torque control to the motor based on the sensor data generated by the inertial measurement unit;
determine a second orientation of the power tool relative to the ground surface based on the sensor data generated by the inertial measurement unit;
determine a second corrective torque control to apply to the motor based on the second orientation of the power tool; and
apply the second corrective torque to the motor to reorient the power tool during the free fall.

7. The power tool of claim 1, wherein the controller configured to determine that a collision has occurred between the power tool and the ground surface such that the power tool is no longer in free fall by comparing the sensor data to gravitational acceleration.

8. The power tool of claim 1, wherein the controller is configured to apply the corrective torque control to the motor to reorient the power tool such that the ground surface initially contacts the power tool in the second area of the housing instead of the first area of the housing upon completion of the free fall.

9. A method comprising:
determining, by a power tool, that the power tool is in free fall based on sensor data generated by an inertial measurement unit of the power tool;
determining, by the power tool, an orientation of the power tool relative to a ground surface based on the sensor data generated by the inertial measurement unit of the power tool;
determining, by the power tool, a corrective torque control to apply to a motor of the power tool based on the orientation of the power tool; and
applying, by the power tool, the corrective torque control to the motor to reorient the power tool during the free fall.

10. The method claim 9, wherein:
the sensor data comprises acceleration data and rotational data;
determining, by the power tool, that the power tool is in the free fall is based on the acceleration data; and
determining, by the power tool, the orientation of the power tool relative to the ground surface is based on the rotational data.

11. The method of claim 10, wherein determining that the power tool is in free fall comprises comparing the acceleration data to a threshold.

12. The method of claim 9, wherein determining the corrective torque control to apply to the motor comprises calculating a cross product of an orientation vector and a preferred drop vector for the power tool.

13. The method of claim 12, wherein determining the corrective torque control to apply to the motor comprises multiplying the cross product by an inertia constant specific to the power tool.

14. The method of claim 9, comprising:
determining, by the power tool, that the power tool is still in the free fall after applying the corrective torque to the motor based on the sensor data generated by the inertial measurement unit;
determining, by the power tool, a second orientation of the power tool relative to the ground surface based on the sensor data generated by the inertial measurement unit;
determining, by the power tool, a second corrective torque control to apply to the motor based on the second orientation of the power tool; and
applying, by the power tool, the second corrective torque control to the motor to reorient the power tool during the free fall.

15. The method of claim 9, wherein applying the corrective torque control to the motor to reorient the power tool during the free fall comprises applying the corrective torque control to the motor such that the ground surface initially contacts the power tool in a second area of a housing of the power tool associated with a battery of the power tool instead of a first area of the housing associated with the motor upon completion of the free fall.

16. A power tool comprising:
a housing;
a motor;
a battery;
an inertial measurement unit comprising circuitry that is configured to generate sensor data associated with the power tool; and
a controller in communication with the inertial measurement unit and the motor, the controller comprising a processor and a memory, the processor configured to execute instructions stored in the memory such that the controller is configured to:
determine that the power tool is in free fall based on the sensor data generated by the inertial measurement unit;
determine a corrective control signal to apply to the motor during the free fall; and
apply the corrective control signal to the motor to reorient the power tool during the free fall.

17. The power tool of claim 16, wherein:
the motor is disposed in a first area of the housing;
the battery is disposed in a second area of the housing; and
the controller is configured to apply the corrective control signal to the motor to reorient the power tool during the free fall such that the ground surface initially contacts the power tool in the second area of the housing instead of the first area of the housing upon completion of the free fall.

18. The power tool of claim 16, wherein the controller is configured to determine the corrective control signal to apply to the motor during the free fall by calculating a cross product of an orientation vector and a preferred drop vector for the power tool.

19. The power tool of claim 18, wherein the controller is configured to determine the corrective control signal to apply to the motor during the free fall by multiplying the cross product by an inertia constant specific to the power tool.

20. The power tool of claim 16, wherein the controller is configured to determine that the power tool is in free fall by comparing the sensor data generated by the inertial measurement unit to an acceleration threshold.
